(19) United States
(12) Patent Application Publication
(10) Pub. No.: US 2026/0261492 A1
(43) Pub. Date: Sep. 3, 2026

(54) SELECTING A PATH FOR A SERVICE THROUGH A NETWORK INFRASTRUCTURE

(71) Applicant: Telefonaktiebolaget LM Ericsson (publ), Stockholm (SE)

(72) Inventors: Miljenko OPSENICA, Espoo (FI); Swarup Kumar MOHALIK, Bangalore (IN)

(73) Assignee: Telefonaktiebolaget LM Ericsson (publ), Stockholm (SE)

(21) Appl. No.: 19/489,911

(22) PCT Filed: Jun. 7, 2023
(86) PCT No.: PCT/SE2023/050569

§ 371 Date: Dec. 4, 2025

(51) Int. Cl. H04L 41/5003; H04L 41/16; H04L 45/02

(52) U.S. Cl. CPC H04L 41/5003; H04L 41/16; H04L 45/08

(57) ABSTRACT

Embodiments described herein relate to a method and apparatus for determining a selected path for delivering a service through a network infrastructure, wherein the network infrastructure comprises a plurality of candidate paths for delivery of the 5 service from a source node to one or more candidate end nodes. The method comprises receiving (210) a service request from a first network node for a service, wherein the service request indicates one or more requested service parameters; sparse spike sequence encoding (220) the one or more requested service parameters to generate an encoded service level agreement, SLA; obtaining (230) a resource 10 graph representative of the network infrastructure, wherein the resource graph comprises nodes and edges between the nodes; and utilizing (240) the encoded SLA and the resource graph to select the selected path from the plurality of candidate paths for use in provision of the service.

### TECHNICAL FIELD

Embodiments described herein relate to the field of network design and optimization and, more specifically, to a method and a network service manager, a computer program, a carrier and computer program product for determining a selected path for delivering a service through a network infrastructure, wherein the network infrastructure comprises a plurality of candidate paths for delivery of the service from a source node to one or more candidate end nodes.

### BACKGROUND

Today's network services are mostly managed in the central cloud and deployed either as central cloud services or as part of network slice deployments. Existing services target bigger groups of User Equipments (UEs)/users, and such deployments are not frequently changed. Ongoing Radio Access Network (RAN) evolution in relation to 5G/6G/Open Radio Access Network (ORAN) brings new, more granular RAN deployment options which can provide lighter network capabilities closer to UEs/users and closer to the edge (e.g. utilising edge computing). That way, network services may also be deployed closer to the UEs, utilizing benefits of shorter edge control and operational loops. As a result, more distributed deployments will require more compute and memory resources for service deployment and more resources for optimization management actions.

There are also ongoing trends of moving enterprise service/application deployments closer to the users and data producers, to utilize shorter edge processing and controlling loops. A strong enabler of this is a mobile network with intelligent orchestration mechanisms to optimise network performance parameters such as latency, bandwidth, and jitter. Enterprise services and applications may leverage such intelligent orchestration mechanisms even more with network services distributed further to the edge, giving mutual performance gains.

New distributed network service deployment models bring new complexity in the service management and challenging constraints in resource utilization. New, more granular and more distributed services with new more dynamic usage patterns require more flexible and autonomous service management. The amount of required energy, compute and memory resources may be critical if services need to be deployed full time and in every edge location. The same problem regarding the required resources for a service may be considered an additional cost problem for deployed services which may be being underutilized for periods of time. In other words, deployed services that have been allocated resources may be underutilised, and the resources reserved for their deployment are thus not being efficiently used.

Traditional Artificial Intelligence (AI)/Machine Learning (ML) driven optimizations can help in the prediction of needed resources and services. However, such optimization processes are trained in the central cloud due to high processing power needs and are often based on offline learning from collected network statistics. Existing deployment models are targeting wider network areas and a wider group of UEs, and deployments are not often changed. However, for lightweight services with a stronger relation to UE real-time requirements, services may be changed and re-deployed more frequently.

Thus, there is a need for a network service deployment model that can autonomously optimize service deployments per UE demand, and which can adapt flexibly to the demand dynamics in real-time. Such a network service deployment model may need to cope with new use cases' challenges and new service usage patterns. At the same time, it may be desirable for a network service deployment model to be sustainable and use less energy, compute and memory resources whilst enabling highly distributed services in constrained edge network environments.

### SUMMARY

It will be appreciated that network service deployment models may be required to evolve from the traditional massive deployment models to more adaptive, dynamic, and autonomous models. New models may need to cope with new use cases' challenges and new service usage patterns. At a same time, service management solutions need to be more sustainable and consume less power.

According to some embodiments there is provided a method performed by a network service manager for determining a selected path for delivering a service through a network infrastructure. The network infrastructure comprises a plurality of candidate paths for delivery of the service from a source node to one or more candidate end nodes. The method comprises receiving a service request from a first network node for a service, wherein the service request indicates one or more requested service parameters. The method further comprises sparse spike sequence encoding the one or more requested service parameters to generate an encoded service level agreement (SLA). The method further comprises obtaining a resource graph representative of the network infrastructure, wherein the resource graph comprises nodes and edges between the nodes. The method further comprises utilizing the encoded SLA and the resource graph to select the selected path from the plurality of candidate paths for use in provision of the service.

In some examples, utilizing the encoded SLA and the resource graph to select the selected path from the plurality of candidate paths for use in provision of the service comprises: inputting the encoded SLA into a spike neural network, SNN, derived from the resource graph. As in an SNN all computation is event-driven, meaning that operations are sparse and may occur only when significant changes in the input make them necessary, the use of the SNN to select the selected path may provide power savings.

According to some embodiments there is provided a Network Service Manager, NSM, for determining a selected path for delivering a service through a network infrastructure. The network infrastructure comprises a plurality of candidate paths for delivery of the service from a source node to one or more candidate end nodes. The NSM comprises processing circuitry configured to cause the NSM to receive a service request from a first network node for a service, wherein the service request indicates one or more requested service parameters. The processing circuitry is configured to also cause the NSM to sparse spike sequence encode the one or more requested service parameters to generate an encoded service level agreement (SLA). The processing circuitry is configured to also cause the NSM to obtain a resource graph representative of the network infrastructure, wherein the resource graph comprises nodes and edges between the nodes. The processing circuitry is configured to also cause the NSM to utilize the encoded SLA and the resource graph to select the selected path from the plurality of candidate paths for use in provision of the service.

In some examples, the processing circuitry may be further configured to utilize the encoded SLA and the resource graph to select the selected path from the plurality of candidate paths for use in provision of the service comprises: by inputting the encoded SLA into a spike neural network, SNN, derived from the resource graph. As in an SNN all computation is event-driven, meaning that operations are sparse and may occur only when significant changes in the input make them necessary, the use of the SNN to select the selected path may provide power savings.

According to some embodiments there is provided a computer program comprising instructions which, when executed on at least one processor, cause the at least one processor to carry out a method as described above or herein.

According to some embodiments there is provided carrier containing a computer program as described above wherein the carrier comprises one of an electronic signal, optical signal, radio signal or computer readable storage medium.

According to some embodiments there is provided a computer program product comprising non transitory computer readable media having stored thereon a computer program as described above.

An object of the invention is therefore to enable sustainable and power efficient methods for path selection for services.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 depicts an example of a network service management architecture for autonomous distributed network service management;

FIG. 2 is a flowchart illustrating an example method 200 for determining a selected path for delivering a service through a network infrastructure comprising a plurality of candidate paths for delivery of the service;

FIG. 3 illustrates an example of a resource graph representative of the infrastructure of a network;

FIG. 4 illustrates an example of the architecture for an SNN utilizing the resource graph illustrated in FIG. 3;

FIG. 5 illustrates an example of the communication between the neurons in the SNN of FIG. 4;

FIG. 6 is a signalling diagram illustrating an example implementation of the method in relation to a neuromorphic computing embodiment;

FIG. 7 illustrates an NSM comprising processing circuitry (or logic);

FIG. 8 is a block diagram illustrating an NSM according to some embodiments

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate.

Likewise, any advantage of any of the embodiments may apply to any other embodiments, and vice versa. Other objectives, features and advantages of the enclosed embodiments will be apparent from the following description.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not to obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Certain aspects of the present disclosure and their embodiments may provide solutions to these or other challenges. The steps of any methods disclosed herein do not have to be performed in the exact order disclosed, unless a step is explicitly described as following or preceding another step and/or where it is implicit that a step must follow or precede another step.

Particular embodiments are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Some embodiments include methods performed by a network service manager for determining a selected path for a service from a plurality of candidate paths.

Embodiments described herein provide a low power network service deployment solution which use, for example, a foundation of neuromorphic computing for enabling autonomous edge network service management. An edge network service manager, NSM, may process dynamic user equipment (UE) service requests and use neuromorphic computing to calculate best matching service allocation/deployment path. Neuromorphic computation considers inputs such as: UE requirements on network service (e.g. latency, throughput, jitter, packet lost), network knowledge on network edge resources (network edge resources are modelled here as nodes and edges in a resource graph) comprising hardware resources (e.g. compute and memory resources), software resources (for example, OS and virtualization) and transport resources (e.g. latency and bandwidth resources on edges between nodes), existing service availability, service request demand and service pattern trends, cost of deployment, etc. Some embodiments may encode a service request input using sparse spike sequence encoding for input into, for example, a spike neural network which uses human brain centric neuron mechanisms to determine a selected path to perform the requested service. The service request input may comprise a specification of a requested latency, bandwidth, compute and memory resources for provision of the requested service. Path neurons consider a resource graph comprising network nodes and edges and an encoded service level agreement (SLA) representing performance characteristics encoded as composite weights or thresholds. Neuron events then trigger neuron composite states within path neurons where user-defined rules can additionally prioritize allocation of particular paths, for example if more than one path spikes in response to the encoded SLA. With such prioritization the proposed solution can be used for neuromorphic computing-based training where service management can learn while addressing different management dynamics such as: service demands and service usage patterns; traffic patterns; resource availability trends, etc.

By the nature of neuromorphic computing, some embodiments consume low energy, compute and memory resources to manage and optimize deployment decisions. With autonomous management solutions deployed at the edge (e.g. network edge), some embodiments also simplify management complexity with simplified local deployment topology options as well as with narrowed management focus on locally used services. The service requirements may then be managed in parallel by multiple edge network service managers and independently across different edge locations. Services decommissioning may be triggered by similar neuromorphic principles where, for instance, low consumption of the service can be captured similarly as in service deployment triggering with an inverted triggering logic for decommissioning.

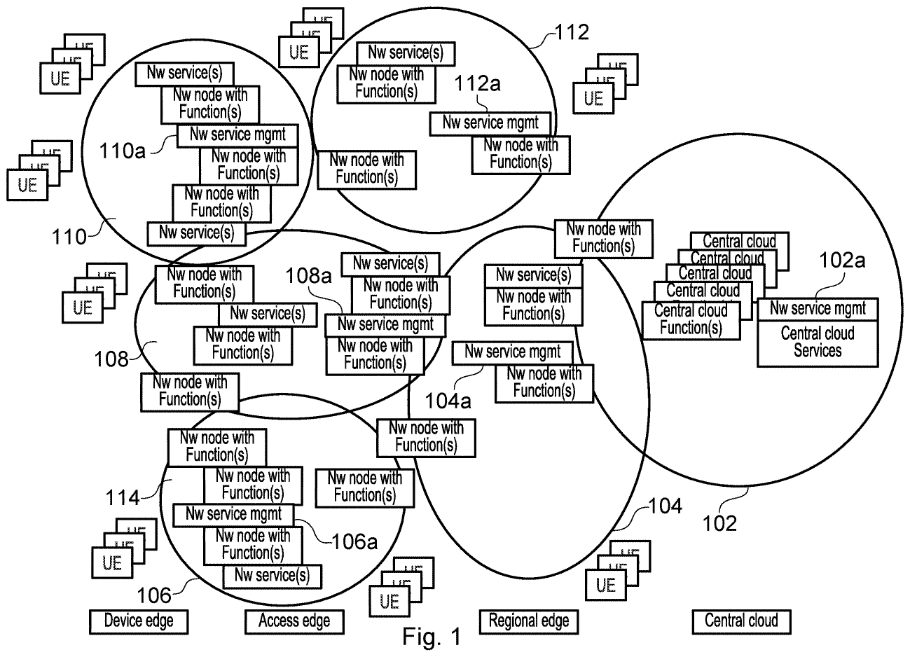

FIG. 1 depicts an example of a network service management architecture for autonomous distributed network service management. The area constrained by the oval 102 on the rightmost side of FIG. 1 represents the central cloud, wherein the central cloud may comprise a network service manager (NSM) 102a for managing central cloud functions and a network node. The area constrained by the oval 104 represents the network edge, wherein the network edge may comprise an NSM 104a and one or more network nodes. The area of the network edge 104 may comprise a RAN area or a network access edge or a part of a network-wide area edge. The network edge 104 may be in communication with the central cloud 102. The areas constrained by the four ovals 106, 108, 110 and 112 on the leftmost side of FIG. 1 represent the access edge of the network (e.g. a radio access network area), wherein the access edge 106-112 may comprise NSMs 106a to 112a and one or more network nodes.

The access edge 106-112 may be in communication with the network edge 104.

It will be appreciated that each oval 102 to 112 comprises an NSM 102a to 112a that may be configured to manage functions of the one or more network nodes within the oval.

The area 114 surrounding the access edge not constrained by the ovals 106, 108, 110 and 112 depicts the device edge, wherein the device edge comprises wireless devices.

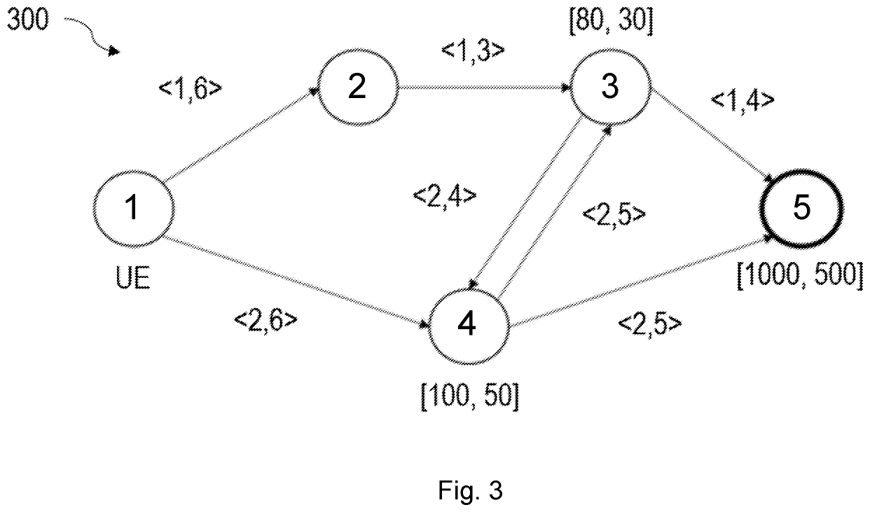

The Edge NSMs 102 to 112 may perform autonomous network service management using proposed intelligent (for example, neuromorphic) computing processes herein. By having the autonomous management solution deployed at the edge network (e.g. within the network edge 104 or access edge 106 to 112), management complexity may be simplified with a simplified local deployment topology as well as with a narrowed focus on a local active subset of services. In other words, as the NSMs are not deployed centrally, the resource graph (e.g. as illustrated in FIG. 3) that they consider when selecting paths for services may be focused on a smaller local topology of the available resources.

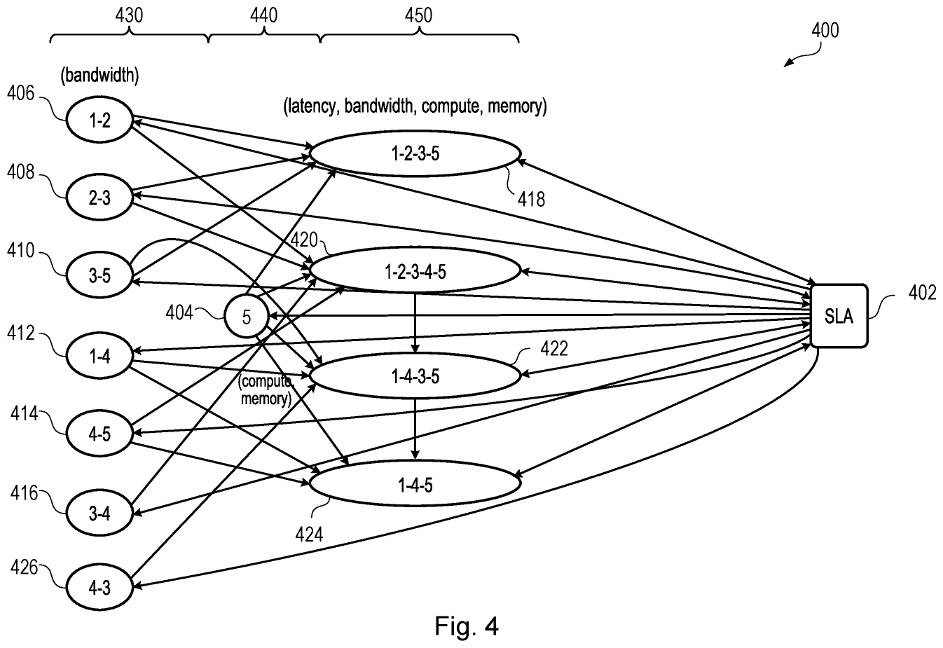

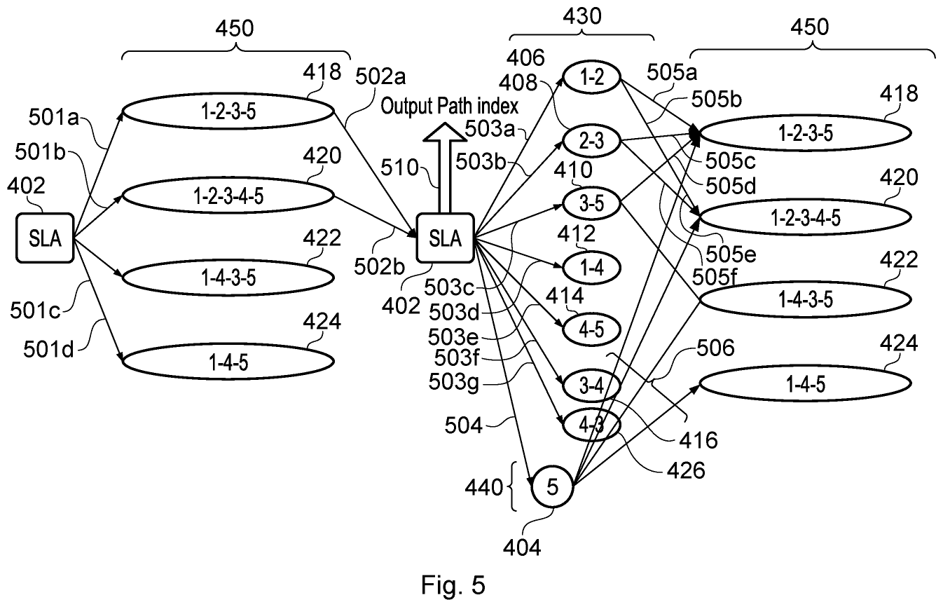

FIG. 1 illustrates that the service requests (for example from the wireless devices) may be managed in parallel by multiple edge NSMs (e.g. NSMs 102a to 112a) and independently across the different edge locations. The deployment of edge NSMs may also use the neuromorphic embodiments described herein (e.g. as described with reference to FIGS. 4 and 5) wherein the edge NSMs may be also deployed where they are most needed (e.g. a most frequently used edge network node). In one embodiment, some aggregated knowledge across existing managers may be utilised to trigger a new (e.g. optimal) allocation of an additional NSM.

The edge NSMs may be used in the context of Open Radio Access Network (ORAN) and Service Management and Orchestration (SMO) management. There may be a need to optimize SMO based management for the new RAN edge deployment models. RAN deployment models may use different combinations of network functions and more distributed deployments. Deployment models at edge locations may be needed to scale down network service deployments. There may also be a need to keep management loops closer to the service deployments and scale down SMO management solution.

The Edge NSMs may also be used in Edge-SMO network management where a new layer of network services would be deployed above deployed Radio Access Network (RAN) or Core Network (CN) functions. Such network services may be deployed close to the related RAN network functions and closer to the users (e.g. intelligent radio applications (rApps) users or rApp's network services). The use of edge NSMs may also be related to Global Network Platform concepts where lightweight network services can be offered to end users higher in the stack where end users may be users of devices/UEs or small enterprises. The stack refers to typical technology stack layers from lower, more infrastructure related layers to higher, more application related layers.

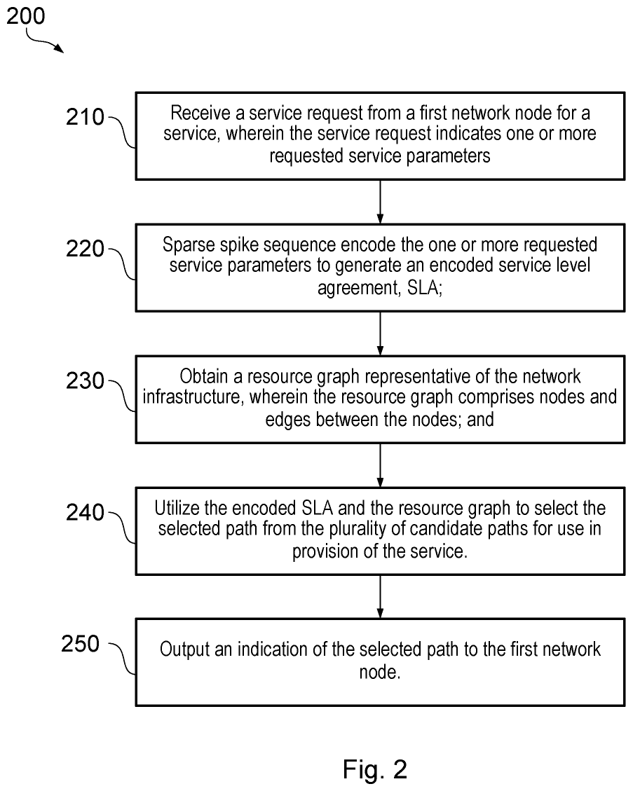

FIG. 2 is a flowchart illustrating an example method 200 for determining a selected path for delivering a service through a network infrastructure comprising a plurality of candidate paths for delivery of the service.

The method 200 may be performed by a NSM, for example any of the NSMs 102a to 112a illustrated in FIG. 1, and may be implemented in a computing device or server apparatus and/or in a virtualized environment, for example in a cloud, edge cloud or fog deployment.

In step 210 an NSM receives a service request from a first network node for a service, wherein the service request indicates one or more requested service parameters. The NSM may process dynamic service requests of a wireless device. The service request may also comprise knowledge of the wireless device (e.g. device-OS knowledge or even knowledge regarding device related services in relation to an application running over the top (OTT)) or user knowledge on service usage patterns. The requested service parameters may comprise information relating to requested performance characteristics, cost requirements and/or other inputs. In some embodiments, the requested service parameters comprise key performance indicators (KPIs) and information relating to a service layer agreement (SLA) for the service.

In some embodiments, the one or more requested service parameters may comprise one or more of a requested latency for the service, L, a requested bandwidth for the service, B, requested compute resources to host the service, C, and requested memory resources to host the service, M.

In step 220 the NSM sparse spike sequence encodes the one or more requested service parameters to generate an encoded SLA.

The encoded SLA of the service may comprise a tuple, <latency, bandwidth, compute, memory>, that specifies the end-to-end latency, bandwidth, compute and memory resources requested by the end application (e.g. at the first network node). In some examples, the NSM may translate the received requested service parameters into pulses or neuron spikes from the encoded SLA (for example as described with reference to FIGS. 4 and 5). The encoded SLA may then be used to select an appropriate path for delivering the service.

Sparse spike sequence encoding may comprise utilizing latency encoding to generate the encoded SLA. Latency encoding is a spike encoding technique and does not relate to the “latency” parameter that may be specified in the encoded SLA. As an illustrative example, if a resolution of a millisecond and a maximum latency of 100 ms is assumed, a requested latency of 30 ms may be encoded as a 0/1 sequence where only the 30th bit is 1. Hence, in this example, whichever bit is equal to 1 may indicate the number of milliseconds of latency. The other parameters may be encoded similarly. The complete spike sequence may therefore comprise a string LBCM, wherein L encodes the requested latency, B encodes the requested bandwidth, C encodes the requested compute resources and M encodes the requested memory resources. The number of bits for L, B, C and M may be fixed and known. In some embodiments the maximum values and the increment represented by each bit are known.

It will be appreciated that the ordering of the requested service parameters in the encoded SLA may be varied and that different methods for sparse spike encoding exist and may be equivalently utilized herein.

The spike-based encoded SLA and its computation may be suitable for neuromorphic hardware (for example as will be described with reference to FIGS. 4 and 5). However, the encoded SLA itself may be input to any software implementation which can decode the spike inputs into numerical values and process them (for example, as will be described with reference to FIGS. 4 and 5).

In step 230 the NSM obtains a resource graph representative of the network infrastructure, wherein the resource graph comprises nodes and edges between the nodes.

Nodes may represent available compute resources and/or memory resources within the network infrastructure, wherein the compute resources may comprise, for example, virtual central processing units (vCPUs). The edges may represent transport resources within the network infrastructure, wherein the transport resources may comprise for example latency and/or bandwidth resources. The edges may be associated with a direction. For example, the communication between two nodes may have different properties depending on the direction of traffic between the two nodes.

A resource graph may comprise one or more source nodes, wherein the source node may correspond to the first network node. It will be appreciated that the first network node may comprise a wireless device any other device requesting a service. In some embodiments, the source node comprises a network node closest to the first network node in the network infrastructure. It may be assumed that the allocation of network resources to support network functions (e.g. core network functions (such as a User plane Function, UPF or Session Management Function, SMF) or application functions AFs) has already been performed, and the remaining resources may be allocated to support lightweight network services on the top, for example, as UE or application tunned functionality. A task to be performed by the edge NSM may then to be to allocate the node where the lightweight network service can be deployed, and to determine the path from the UE to that node.

FIG. 3 illustrates an example of a resource graph representative of the infrastructure of a network. The resource graph comprises five nodes and seven edges between the nodes. In this example, each edge comprises a direction depicted as an arrow directed from a source node and towards a destination node. In this example, each edge is therefore representative of the available transport resources from the associated the source node to the destination node. The resource graph includes example indications of the compute and memory resources within the network infrastructure represented by the nodes. The example indications of the compute and memory resources are depicted as labels on the nodes. Node 3 represents 80 available CPUs and 30 GB available memory. Node 4 represents 100 available CPUs and 50 GB available memory. Node 5 represents 1000 available CPUs and 500 GB available memory. The resource graph also includes example indications of the latency and bandwidth resources within the network infrastructure represented by the edges. The example indications of the latency and bandwidth are depicted as labels on the edges. The edge from node 1 to node 2 represents a latency of 1 ms and a bandwidth of 6 Mbps for traffic sent from node 1 to node 2. The edge from node 1 to node 4 represents a latency of 2 ms and a bandwidth of 6 Mbps for traffic sent from node 1 to node 4. The edge from node 2 to node 3 represents a latency of 1 ms and a bandwidth of 3 Mbps for traffic sent from node 2 to node 3. The edge from node 3 to node 4 represents a latency of 2 ms and a bandwidth of 4 Mbps for traffic sent from node 3 to node 4. The edge from node 3 to node 5 represents a latency of 1 ms and a bandwidth of 4 Mbps for traffic sent from node 3 to node 5. The edge from node 4 to node 3 represents a latency of 2 ms and a bandwidth of 5 Mbps for traffic sent from node 4 to node 3. The edge from node 4 to node 5 represents a latency of 2 ms and a bandwidth of 5 Mbps for traffic sent from node 4 to node 5.

The resource graph 300 comprises a source node, node 1. In this example resource graph, the source node comprises a UE. In this example, the resource graph comprises only one endpoint node, node 5. It will be appreciated that in some examples more than one endpoint node may be available. A path from the source node to the endpoint node may be constrained by edges between the nodes that comply with possible directions for traffic between the nodes which is indicated by the directions of the edges. A plurality of candidate paths from node 1 to node 5 along the edges between the nodes may be calculated.

A resource graph processor (which may be comprised within the NSM or may be located elsewhere) may calculate the available acyclic paths rooted at the source node and their parameters from the resource graph. Given a path from the source node, node 1, terminating in the endpoint node, node 5, if a service is allocated to this path it means the service endpoint function is hosted in the endpoint node, node 5 and appropriate network resources are allocated on the edges on the path and at the endpoint node to meet the service requirements.

In the example resource graph 300, the possible acyclic paths from node 1 to node 5 are as follows:
Path 1: node 1-node 2-node 3-node 5
Path 2: node 1-node 2-node 3-node 4-node 5
Path 3: node 1-node 4-node 3-node 5
Path 4: node 1-node 4-node 5

In the example resource graph 300 therefore, Paths 1 to 4 may comprise the plurality of candidate paths for delivering the service.

In step 240 the NSM utilizes the encoded SLA and the resource graph to select the selected path from the plurality of candidate paths for use in provision of the service.

A first example implementation of step 240 may comprise utilising a data-structure to store indications (e.g. values) of the latency and bandwidth available on each edge, and the memory resources and compute resources available at each node that is capable of hosting an application. The data structure may also store indications (e.g. values) of the candidate paths and their associated latencies and bandwidths.

It will be appreciated that the latency of a candidate path may comprise a sum of the latencies associated with each of the edges in the candidate path. The bandwidth associated with a candidate path may comprise the minimum of the bandwidths associated with the edges in the candidate path.

Given an encoded SLA, the endpoint nodes N that have the required compute and memory may be determined. In the example resource graph 300, the node 5 may be determined as an endpoint node.

The candidate paths that end with one of the endpoint nodes N (e.g. node 5), and that have at least the requested latency and bandwidth, may be selected. For the example resource graph 300 it may be that only Paths 1 and 2 have enough bandwidth and low enough latencies to be suitable for the service. If more than one path is selected, the final selected path P may be selected using some logic such as “select the path having the lowest identification number, for example, select Path 1 over Path 2”.

The stored indications of the available compute resources and memory resources in the endpoint node (e.g. node 5) may be updated based on the compute resources and memory resources specified in the encoded SLA. In other words, the data structure may update the indications of the compute resources and memory resources associated with the endpoint (e.g. to reduce the indications by the amounts specified in the encoded SLA). Similarly, the data structure may update the indications of the bandwidths of all of the edges of the selected path by reducing them by the bandwidth indicated in the encoded SLA.

A second example implementation of step 240 may comprise obtaining and utilising an artificial neural network (ANN). Given a resource graph (e.g. resource graph 300) and an encoded SLA, inputs for the ANN may be encoded as a tuple. In some embodiments, the input tuple may be encoded as: Input==<node1, node2, . . . , node0, node1Mem, node1CPU, node2Mem, node2CPU, . . . , edge1, edge2, . . . edgeN, latency_edge1, bandwidth_edge2, . . . path1_latency, path1_bandwidth, . . . >, wherein, for this example input tuple, the resource graph comprises a number, O, of nodes, from node1 to nodeM, wherein O is a positive integer, and a number, N, of edges, from edge1 to edgeN, wherein N is a positive integer. Each node in the set of O nodes may comprise memory and computing resources. In this example, the memory and computing resources comprised by node1 is denoted as node1Mem and node1CPU respectively and the memory and computing resources comprised by node 2 is denoted as node2Mem and node2CPU respectively. Each edge in the set of N edges may comprise available bandwidth and latency resources within the network infrastructure. The latency available on edge 1 is denoted as latency_edge1 and the bandwidth available on edge 2 is denoted as bandwidth_edge 2. A number of candidate paths may be determined from the source node to the terminal node, wherein each candidate path comprises latency and bandwidth resources. The latency and bandwidth on a first candidate path, path1, is denoted as path1_latency and path1_bandwidth respectively.

The output of the ANN may be encoded as a tuple: Output==<i>, wherein “i” is the index of a selected path.

Training samples of <input, output> pairs may be obtained by using the first example implementation described above, and these may be used as training examples for an ANN, with appropriate input and output dimensions. Obtaining appropriate input dimensions may comprise utilizing encoding such as binary or one-hot encoding. Obtaining appropriate output dimensions may comprise utilizing binary or one-hot encoding of the path indices.

Neuromorphic computing (NC) has attracted a lot of attention because of its artificial intelligence functions whilst consuming an ultra-low power of less than 20 watts by mimicking the human brain. Spiking neural networks (SNNs) are artificial neural networks that more closely mimic natural neural networks. The fundamental idea is that in a spiking network, all computations are event-driven, meaning that operations are sparse and occur only when significant changes in the input make them necessary.

A third example implementation of step 240 may comprise obtaining and utilizing a spiking neural network (SNN). The sparse spike sequence encoding used to determine the encoded SLA in step 220 may be implemented in a neuromorphic processor to give the advantage of low power consumption. It will be appreciated that it is possible to use the method described in the second example implementation above utilizing an ANN and then translate the ANN to a corresponding SNN. However, there are findings that such translations do not result in the expected power benefits. Therefore, a direct implementation of an SNN may be obtained and used by the NSM in some examples of step 240.

For example, step 240 may comprise inputting the encoded SLA into an spike neural network, SNN, wherein the SNN is derived from the resource graph.

For example, the architecture of the SNN may result from a mapping from a resource graph (such as the example resource graph 300) to the neurons of the SNN. For example, the nodes of the resource graph are mapped to node neurons and edges of the resource graph are mapped to edge neurons. Furthermore, there is a mapping of the candidate paths to path neurons.

In one embodiment, responsive to a change in the network infrastructure, and hence when nodes and edges of the resource graph changes, the SNN may be updated to incorporate resulting changes to the resource graph. Therefore, the architecture of the SNN may be dynamically recomputed.

It will be appreciated that the SNN may be determined by the NSM or may be received from another node in the network or provided by an orchestration or management node.

In general network services are event based and therefore have great coherence with the way in which an SNN works in that events can be very random and, therefore, a spike encoding may be able capture such randomness with a minimal resource footprint. The use of an SNN as described above also fits with general resource constraints at in edge networking where classical methods may not be possible and may be very costly. At the same time, real time requirements in control and service usage means that control services may need to be placed as close as possible to the UE. It will be appreciated that classical methods may be used to analyse aggregated insights across edges and recommend updates on network optimization intents.

FIG. 4 illustrates an example of the architecture for an SNN utilizing the resource graph illustrated in FIG. 3.

The SNN comprises a service request neuron 402. The service request neuron 402 may utilise the encoded SLA to trigger the other neurons in the SNN.

The SNN 400 comprises a set of node neurons 440, wherein each node neuron corresponds to a candidate end node in the resource graph. FIG. 4 depicts one node neuron 404 corresponding to node 5, the only candidate endpoint node in FIG. 3. Each node neuron stores an indication of current compute resources and current memory resources available at the corresponding candidate end node.

The SNN 400 also comprises a set of edge neurons 430, wherein each edge neuron corresponds to an edge between two nodes in the resource graph. FIG. 4 depicts seven edge neurons, 406, 408, 410, 412, 414, 416 and 426, corresponding to seven edges between the nodes in FIG. 3. Each edge neuron stores an indication of a current bandwidth available at the corresponding edge in the resource graph.

The SNN 400 also comprises a set of path neurons 450, wherein each path neuron corresponds to a candidate path from a source node to a candidate endpoint node in the resource graph. FIG. 4 depicts four path neurons, 418, 420, 422 and 424, corresponding to the four paths from node 1 to node 5 in FIG. 3. Each path neuron stores indications of the current compute resources and current memory resources at the candidate end node of the corresponding candidate path, a current minimum bandwidth available at the edges in the corresponding candidate path and a latency of the corresponding candidate path.

The arrows in FIG. 4 illustrate the possible connections between the various neurons present.

It will be appreciated that the structure of the SNN, and the number of neurons in the sets 430, 440 and 450 may be dependent on the structure of the resource graph from which the SNN is determined.

FIG. 5 illustrates an example of the communication between the neurons in the SNN 400. The neurons have been depicted with corresponding reference numbers to those used in FIG. 4.

It will be appreciated that only those connections (indicated by arrows) that spike in the duration of this example of utilising the SNN are illustrated in FIG. 5 for clarity. Other connections (such as those illustrated in FIG. 4) are of course possible, and may spike in other instances of utilising the example SNN.

FIG. 5 depicts the chronological communication between the neurons from the left of the figure across to the right. Starting from the service request neuron 402, an SLA request may be translated by updating the service request neuron 402 with the <latency, bandwidth, compute, memory> request and a START trigger.

The service request neuron 402 may then produce the encoded SLA for the path neurons 504 to process. The encoded SLA may comprise the LBCM string as described above. The service request neuron 402 transmits the encoded SLA to the set of path neurons 450 in steps 501a to 501d.

Each path neuron in the set of path neurons 450 receives the encoded SLA from the service request neuron and may use, for example, counters to determine if the corresponding candidate path can host the service or not. Each path neuron in the set of path neurons 450 may determine whether the corresponding candidate path can host the service based on a set of conditions relating to the received encoded SLA. If the set of conditions are met, the path neuron may determine that the corresponding candidate path is able to host the service. The set of conditions may comprise the current minimum bandwidth available at the edges in the corresponding candidate path being greater than or equal to B in the encoded SLA; the current compute resources at the candidate end node of the corresponding candidate path being greater than or equal to C in the encoded SLA; the current memory resources at the candidate end node of the corresponding candidate path being greater than or equal to M in the encoded SLA; and/or the latency of the corresponding candidate path being less than or equal to L in the encoded SLA.

An example implementation of this logic used for the condition on latency, L, is given by the following pseudocode:

```
AvailableLatency = N (wherein N is a concrete value calculated for the path)
Temp = AvailableLatency
T = |L|
Loop:
  no spike −> T--;Temp--; if Temp == 0 then canProvideLatency = True; break
  spike −> canNotProvideLatency = True; Temp = 0; break
Loop:
  T—
Till T == 0.
```

As an illustrative example, the corresponding candidate path for a path neuron may be assumed to have an AvailableLatency 5 ms which is used to initialize a counter referred to as “Temp” to 5 ms. The spike train for latency is of length |L|, which as an illustrative example may be assumed to equal 20. The service request neuron may be assumed to output a spike train for latency 10 ms, hence the spike train has a spike (e.g. a bit with a value of 1) at only the 10th bit and bits with the value 0 elsewhere. In the loop, since there are no spikes in the input until the 10th bit, Temp is decremented to 0 first. This denotes that the latency provided by the path, 5 ms, is less than the required latency, 10 ms. Hence, the path sets the output spike on the output canProvideLatency.

However, as an illustrative example, if the requested latency in the encoded SLA was assumed to be equal to 3 ms, and hence less than the candidate path latency, the input spike will occur before Temp is reduced to 0. Therefore, canNotProvideLatency is set to spike. In this case, the candidate path cannot provide the required latency as the required latency is smaller than it can provide. In this case, Temp is set to 0 so that in the next cycles it will continue to be negative, and so less than 0, and hence will not spike on canProvideLatency because the condition Temp==0 will never be true.

It will be appreciated that similar logic may be applied for the conditions relating to bandwidth, compute resources and memory resources.

Each path neuron in the set of path neurons 450, responsive to the path neuron determining, based on the received encoded SLA, that the corresponding candidate path neuron can host the service, may transmit at least one spike response to the service request neuron. The at least one response spike may be transmitted on a response synapse for the path (i), referred to as PathResponse(i). This response spike may indicate to the service request neuron that the path neuron is associated with a candidate path that can host the service.

In some examples, each path neuron may output a plurality of response spikes indicating that the candidate path can provide one or more of the various resources requested, for example, that response spikes may indicate respectively whether the candidate path can provide the requested latency, the requested bandwidth, the requested compute resources, and the requested memory resources.

If the service request neuron 402 receives one or more response spikes on PathResponse(i) synapse, it means a Path (i) is capable of hosting the service. The service request neuron 402 may select the selected path (e.g., the selected path for delivering the service) corresponding to a selected path neuron from among one or more path neurons that transmitted a spike response to the service request neuron.

In the example illustrated in FIG. 5, the path neurons 418 and 420 transmit response spikes to the service request neuron 402 in steps 502a and 502b indicating that Path 1 and Path 2 are capable of hosting the service.

If, as in the example above, the service request neuron 402 receives a plurality of spike responses indicating that more than one candidate path is capable of hosting the service, the service request neuron 402 may select the final selected path using some internal logic. In one embodiment, the service request neuron 402 may select the final selected path based on alphabetical or numerical order. In another embodiment, the step of the service request neuron 402 selecting a selected path corresponding to a selected path neuron comprises utilizing intent-based prioritization for multiple-end points.

For example, the service request neuron 402 may utilize defined intent-based rules to prioritize an allocation of a particular path, wherein utilizing intent-based prioritization may allow some performance features or deployment strategy to be prioritized and run against the candidate paths. The defined intent-based rules may comprise the service request neuron 402 selecting a path such that at least one of: the selected path comprises the lowest deployment cost of the candidate paths, the selected path obtains a faster reaction in triggering certain services, the selected path prioritizes a selected network performance characteristic, and the selected path utilises a preferred candidate endpoint. Intent here can be related to deployment wide area optimization intent that can come from network entities handling wide area orchestration and can have prioritization criteria based on ongoing dynamics in deployment and learnings on trends such as: service demands and service usage patterns; traffic patterns; resource availability trends, related trainings of optimization models.

In some examples, if multiple path neurons trigger and there is a need to select one from among them, for example, according some preferred order, the following scheme may be utilised in order to perform the selection:
the output of N path neurons may comprise a spike train each of length N. If the path K can provide the SLA, the K'th bit of the N length spike train may spike. The preference constraints spike train is N\hat{ }2 long. If there are 3 paths, we can model the preference order of path 2, path 3 then path 1 as T=[[0,1,0], [0,0,1], [1,00]]. Suppose paths 1 and 3 are feasible paths. The corresponding path neurons output spike train [1,0,0] and [0, 0, 1], respectively. A selector neuron may then process or compare [1,0,0] and [0,0,1] one-by-one with the elements of T in order, starting with T[0] for example by doing a bit-wise AND. Since the result for both [1, 0, 0] and [0, 0, 1] in this case is false, the selector neuron may then repeat the process with T[1]. In this case, the result is true for [0, 0, 1], and the selector neuron may produce an output train with a spike at the 3^{rd} bit. Therefore, between paths 1 and 3, due to the preference order modelled in T, path 3 is selected.

Such intent-based prioritization may be used to train the SNN in a path selection process.

In the example of FIG. 5, the service request neuron 402 selects Path 1 and the corresponding selected path neuron 418.

The service request neuron 402 may output an indication of the selected path to the set of edge neurons 430 and the set of node neurons 440 by outputting a spike selectedPath(i) synapse to all the edge and node neurons.

The service request neuron 402 may transmit a spike encoding of the requested bandwidth, B, to the set of edge neurons 430. The service request neuron 402 may also transmit a spike encoding of the requested compute resources, C, and the requested memory resources, M, to the set of node neurons 440.

In the example of FIG. 5 therefore, the service request neuron then transmits an indication of the selected path, selectedpath(i) (in the example of FIG. 5, Path 1), and the requested bandwidth to the set of edge neurons 430 in steps 503a to 503g. The service request neuron 402 also transmits an indication of the selected path, selectedpath(i), the requested compute resources, C, and the requested memory resources, M, to the set of node neurons 440 in step 504.

The service request neuron 402 may in some examples output a spike 510 on the Output(i) synapse that is available externally to the NSM to, for example, a user.

When the set of edge neurons 430 are triggered with the selectedPath(i) trigger, they may check if they are part of the Path (i). Responsive to an edge neuron corresponding to an edge forming part of the selected path, the edge neuron may update the indication of the current bandwidth available at the corresponding edge by reducing the stored indication of the current bandwidth by the requested bandwidth, B. In other words, the edge neuron may process the B spike received from the service request neuron in step 503a to 503g to subtract the requested bandwidth, B, from the stored indication of the current bandwidth at the edge neuron.

In the example of FIG. 5, the edge neurons 406, 408 and 410 correspond to edges that are part of the selected path, Path 1. These edge neurons 406, 408 and 410 therefore update their current bandwidths as described above.

The edge neurons may then output a spike encoding of the updated current bandwidth. For example, responsive to an edge neuron updating the current bandwidth available at the corresponding edge, the edge neuron may transmit a spike encoding of the current bandwidth available at the corresponding edge to each path neuron corresponding to a candidate path comprising the corresponding edge.

In the example of FIG. 5 therefore the edge neuron 406 transmits a spike encoding of the updated current bandwidth to the path neurons 418 and 420 in steps 506a and 506b. The edge neuron 408 transmits a spike encoding of the updated current bandwidth to the path neurons 418 and 420 in steps 506c and 506d. The path neuron 410 transmits a spike encoding of the updated current bandwidth to the path neurons 418 and 422 in steps 506e and 506f.

When the set of node neurons 440 are triggered with the selectedPath(i) trigger, they may check if they are the endpoint node of Path (i). Responsive to the node neuron corresponding to a candidate end node forming part of the selected path: the node neuron may update the indication of the current compute resources available at the corresponding candidate end node by reducing the indication of current compute resources by the requested compute resources, C; and update the indication of current memory resources available at the corresponding candidate end node by reducing the indication of the current memory resources by the requested memory resources, M. In other words, if the node neuron is the candidate end node at the end of the selected path, they may process the CM spike received from the service request neuron 402 to update the associated stored indications of the compute resources and memory resources.

In the example of FIG. 5 therefore the node neuron 404 corresponds to the candidate end node of the selected path, Path 1. The node neuron 404 therefore updates its stored indication of the compute resources and memory resources as described above.

The node neuron may then transmit a spike encoding of the updated compute resources and memory resources. For example, responsive to the node neuron updating the indication of the current compute resources and the indication of the current memory resources available at the corresponding candidate end node, the node neuron may transmit a spike encoding of the indication of the current compute resources and the indication of the current memory resources to each path neuron corresponding to a candidate path comprising the corresponding candidate end node.

In the example of FIG. 5 therefore, the node neuron 404 transmits a spike encoding of the updated compute resources and memory resources to the set of path neurons 450, as, in this example, the node 5 is the candidate endpoint of each of the plurality of paths.

In some embodiments, the method 200 may further comprise step 250, in which the NSM outputs an indication of the selected path to the first network node. It will be appreciated that the first network node may utilise the indication of the selected path to

In the first example implementation of step 240, the final selected path P may be output after the final selected path P is selected using some logic. The index of the output final selected path P may then be used in the second example implementation of step 240 as the output of the tuple <input, output> pair used for training the ANN.

In the third example implementation of step 240, after the service request neuron 402 selects the selected path corresponding to a selected path neuron from among one or more path neurons that transmitted a spike response to the service request neuron, the NSM may decode the selected path into a service allocation action. The NSM may use the outcome to trigger service allocation or deployment actions on the selected path. If the service exists, the service allocation may be executed. If the service does not exist on the selected path, the NSM may execute a deployment or instantiation action.

The decoding may translate the outcome (e.g. the selected path) into the allocation/deployment management actions. The NSM may then then use the allocation/deployment management actions as service allocation/deployment actions.

In the case the selected path is local the NSM may execute the actions locally. In the case when selected path indicates external neighborhood network nodes, the service allocation request may be routed to target node.

The description herein focuses on local autonomous edge deployment optimization and an edge NSM for simplicity. However, it will be appreciated that a autonomous edge NSM may also further interact with the other edge NSMs as well as with a central NSM for the further synchronization across the network and joint learnings.

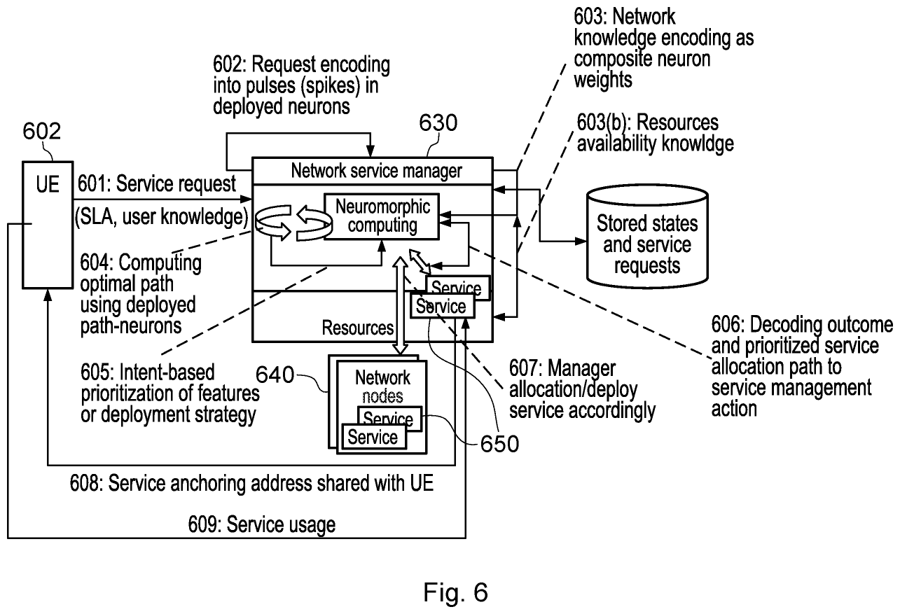

FIG. 6 is a signalling diagram illustrating an example implementation of the method 200 in relation to a neuromorphic computing embodiment.

In other words, the third example implementation of step 240 is implemented in FIG. 6. In this example, the method 200 is performed by an NSM 630. It will be appreciated that the NSM in FIG. 6 may implement one or more of the other example implementations of step 204.

The example implementation begins at step 601, wherein step 601 comprises an example implementation of step 210. In step 601, a first network node, depicted as a UE 620 in FIG. 6, transmits a service request to an NSM 630. The service request may comprise, as depicted in FIG. 6, wireless device or user knowledge on service usage patterns and requested service parameters comprising information relating to a service layer agreement (SLA) for the service.

For request routing purposes, some existing network mechanisms may be applied, where for instance a first network node, e.g. a UE, is allocated to a closest base station or network node. The service may comprise any service related to targeted network capability. Targeted lightweight services may need to be flexible for deployments in constrained edge network in order to support new service usage patterns and address even granular UE demands. Thus, some embodiments may be deployed in lightweight virtualization environments such as a bytecode based Webassembly environment. However, some embodiments may leverage any other less flexible and heavier virtualization environments.

Step 602 is an example implementation of steps 220. In step 602, the NSM 630 sparse spike sequence encodes the requested service parameters received from the UE 620 into an encoded SLA comprising for example spikes for deployed neurons. The encoded SLA of a service may comprise a tuple, <latency, bandwidth, compute, memory>, that specifies the end-to-end latency, bandwidth, compute and memory resources requested by the UE 620.

In step 603 and 603b the NSM obtains a resource graph representative of the network infrastructure (e.g. an example implementation of step 230), and utilizes the resource graph to determine an SNN (e.g. as described with reference to FIGS. 4 and 5).

Network service manager uses network knowledge on network infrastructure such as insights on performance and capabilities, existing service availability, to parametrize path-based neurons. Inputs may be encoded as composite thresholds in the neurons. Service requests and calculated paths may be stored in data storage for the further usage of the SNN.

Steps 604 and 605 comprise an example implementation of step 240.

Step 604 comprises the NSM 630 using the encoded SLA and the SNN to determine the selected path for delivering the service, for example as described with reference to FIGS. 4 and 5.

In step 605, the NSM 630 informs the selection of the selected path utilizing intent-based prioritization, for example, for multiple-end points, wherein some performance features or deployment strategies may be prioritized and run against other candidate paths. As result one or more paths can be prioritized and shared as the outcome of the neuromorphic computation.

In step 606, the outcome of the neuromorphic computation performed by the NSM 630, wherein the outcome comprises the selected path, is decoded into a service allocation.

Step 607 comprises the NSM 630 using the outcome to trigger service allocation or deployment actions on the selected path. If the service exists, the service allocation may be executed. This example is depicted in FIG. 6, wherein network nodes 640 for supporting the service 650 are illustrated. If the service it not currently available on the selected path, the NSM 630 may execute a deployment or instantiation action in the appropriate computing resources to make the service available on the selected path.

Step 608 comprises the NSM 630 sharing a service anchoring address with the UE 620 in a request response, wherein the service anchoring address may comprise the address of the node selected to provide the service (e.g. the e.g. the end node of the selected path). Step 608 comprises an example implementation of step 250 of FIG. 2.

Step 609 comprises the UE 620 connecting to the service 650 using anchoring data and starting to use the service 650.

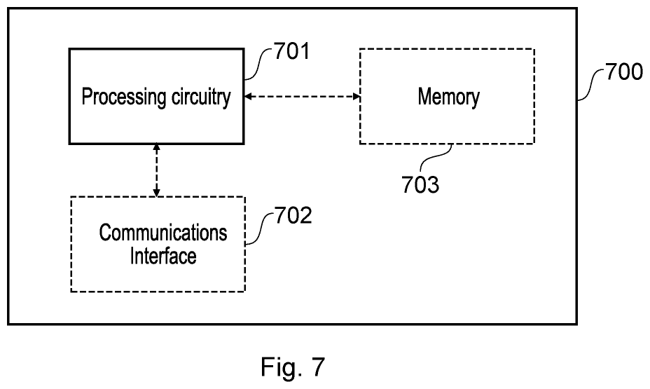

FIG. 7 illustrates an NSM 700 comprising processing circuitry (or logic) 701. The processing circuitry 701 controls the operation of the NSM 700 and can implement the method described herein in relation to an NSM 700. The processing circuitry 701 can comprise one or more processors, processing units, multi-core processors or modules that are configured or programmed to control the NSM 700 in the manner described herein. In particular implementations, the processing circuitry 701 can comprise a plurality of software and/or hardware modules that are each configured to perform, or are for performing, individual or multiple steps of the method described herein in relation to the NSM 700. It will be appreciated that the NSM 700 may comprise one or more virtual machines running different software and/or processes. The NSM 700 may therefore comprise, or be implemented in or as one or more servers, switches and/or storage devices and/or may comprise cloud computing infrastructure that runs the software and/or processes.

Briefly, the processing circuitry 701 of the NSM 700 is configured to receive a service request from a first network node for a service, wherein the service request indicates one or more requested service parameters; sparse spike sequence encode the one or more requested service parameters to generate an encoded service level agreement, SLA; obtain a resource graph representative of the network infrastructure, wherein the resource graph comprises nodes and edges between the nodes; and utilize the encoded SLA and the resource graph to select the selected path from the plurality of candidate paths for use in provision of the service.

In some embodiments, the NSM 700 may optionally comprise a communications interface 702. The communications interface 702 of the NSM 700 can be for use in communicating with other nodes, such as other virtual nodes. For example, the communications interface 702 of the NSM 700 can be configured to transmit to and/or receive from other nodes requests, resources, information, data, signals, or similar. The processing circuitry 701 of NSM 700 may be configured to control the communications interface 702 of the NSM 700 to transmit to and/or receive from other nodes requests, resources, information, data, signals, or similar. The communications interface 702 can use any suitable communication technology.

Optionally, the NSM 700 may comprise a memory 703. In some embodiments, the memory 703 of the NSM 700 can be configured to store program code that can be executed by the processing circuitry 701 of the NSM 700 to perform the method described herein in relation to the NSM 700. Alternatively or in addition, the memory 703 of the NSM 700, can be configured to store any requests, resources, information, data, signals, or similar that are described herein. The processing circuitry 701 of the NSM 700 may be configured to control the memory 703 of the NSM 700 to store any requests, resources, information, data, signals, or similar that are described herein. The NSM 700 may be configured operate in the manner described herein in respect of an NSM.

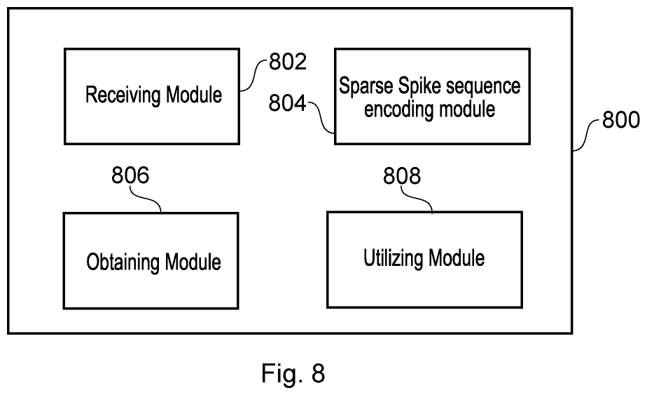

FIG. 8 is a block diagram illustrating an NSM 800 according to some embodiments. The NSM 800 can determine a selected path for delivering a service through a network infrastructure, wherein the network infrastructure comprises a plurality of candidate paths for delivery of the service from a source node to one or more candidate end nodes. The NSM 800 comprises a receiving module 802 configured to receive a service request from a first network node for a service, wherein the service request indicates one or more requested service parameters. The NSM 800 comprises a sparse spike sequence encoding module 804 configured to sparse spike sequence encode the one or more requested service parameters to generate an encoded service level agreement, SLA. The NSM 800 further comprises an obtaining module 806 configured to obtain a resource graph representative of the network infrastructure, wherein the resource graph comprises nodes and edges between the nodes. The NSM 800 further comprises a utilizing module 808 configured to utilize the encoded SLA and the resource graph to select the selected path from the plurality of candidate paths for use in provision of the service. The NSM 800 may operate in the manner described herein in respect of an NSM.

There is also provided a computer program comprising instructions which, when executed by processing circuitry (such as the processing circuitry 701 of the NSM 700 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Embodiments described herein provide low power, low compute, and low memory usage network service management for deployment of network services at, for example, network edge that may serve new network capabilities consuming patterns and may address also end user and smaller enterprise's needs.

Embodiments described herein provide autonomous, dynamic, and flexible deployment solutions that may be used for service deployments as part of existing network mechanisms and may provide service deployment models above the current network functions leveraging on network insights rather than exposing pure data. Deployment models may be also used as potential new design pattern for network function building.

Embodiments described herein provide parallel independent edge NSMs that may scale for highly distributed deployments while addressing highly granular service consumptions.

Embodiments described herein also provide a service deployment model that enables network service higher in the stack with direct impacts on network optimizations.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method performed by a network service manager for determining a selected path for delivering a service through a network infrastructure, wherein the network infrastructure comprises a plurality of candidate paths for delivery of the service from a source node to one or more candidate end nodes, the method comprising:
receiving a service request from a first network node for a service, wherein the service request indicates one or more requested service parameters;
sparse spike sequence encoding the one or more requested service parameters to generate an encoded service level agreement (SLA);
obtaining a resource graph representative of the network infrastructure, wherein the resource graph comprises nodes and edges between the nodes; and
utilizing the encoded SLA and the resource graph to select the selected path from the plurality of candidate paths for use in provision of the service, wherein
utilizing the encoded SLA and the resource graph to select the selected path from the plurality of candidate paths for use in provision of the service comprises:
inputting the encoded SLA into a spike neural network (SNN) derived from the resource graph; and
responsive to a change in the network infrastructure, updating the SNN to incorporate resulting changes to the resource graph.

2. The method of claim 1, wherein
the method further comprises outputting an indication of the selected path to the first network node.

3. The method of claim 1, wherein
the one or more requested service parameters comprise:
a requested latency for the service,
a requested bandwidth for the service,
requested compute resources to host the service, and/or
requested memory resources to host the service.

4. The method of claim 1, wherein
the step of sparse spike sequence encoding comprises utilizing latency encoding to generate the encoded SLA.

5. (canceled)

6. The method of claim 1, wherein the method further comprises obtaining the SNN, wherein the SNN comprises:
a set of node neurons, wherein each node neuron corresponds to a candidate end node in the resource graph;
a set of edge neurons, wherein each edge neuron corresponds to an edge between two nodes in the resource graph; and
a set of path neurons, wherein each path neuron corresponds to a candidate path; and
a service request neuron.

7. The method of claim 6, wherein:
each node neuron stores an indication of current compute resources and current memory resources available at the corresponding candidate end node;
each edge neuron stores an indication of a current bandwidth available at the corresponding edge; and
each path neuron stores indications of:
the current compute resources and current memory resources at the candidate end node of the corresponding candidate path,
a current minimum bandwidth available at the edges in the corresponding candidate path, and
a latency of the corresponding candidate path.

8. The method of claim 7, wherein
the step of utilizing further comprises:
the service request neuron transmitting the encoded SLA to the set of path neurons;
in each path neuron in the set of path neurons: responsive to the path neuron determining, based on the received encoded SLA, that corresponding candidate path can host the service, transmitting a spike to the service request neuron; and
the service request neuron selecting the selected path corresponding to a selected path neuron from among one or more path neurons that transmitted a spike to the service request neuron.

9. The method of claim 8, wherein:
the method further comprises, in each path neuron in the set of path neurons, determining, based on the received encoded SLA, that the path neuron can host the service responsive to:
the current minimum bandwidth available at the edges in the corresponding candidate path being greater than or equal to a requested bandwidth for the service;
the current compute resources at the candidate end node of the corresponding path being greater than or equal to a requested compute resources for the service;
the current memory resources at the candidate end node of the corresponding candidate path being greater than or equal to a requested memory resources for the service; and
the latency of the corresponding candidate path being less than or equal to a requested latency for the service.

10. The method of claim 9, wherein
the method further comprises:
the service request neuron outputting an indication of the selected path to the set of edge neurons and the set of node neurons;
the service request neuron transmitting a spike encoding of the requested bandwidth to the set of edge neurons; and
the service request neuron transmitting a spike encoding of the requested compute resources and the requested memory resources to the set of node neurons.

11. The method of claim 10, wherein
the method further comprises, in each edge neuron in the set of edge neurons:
responsive to the edge neuron corresponding to an edge forming part of the selected path, updating the indication of the current bandwidth available at the corresponding edge by reducing the indication of the current bandwidth by the requested bandwidth.

12. The method of claim 11, wherein
the method further comprises, in each edge neuron in the set of edge neurons:
responsive to the edge neuron updating the current bandwidth available at the corresponding edge, transmitting a spike encoding of the current bandwidth available at the corresponding edge to each path neuron corresponding to a candidate path comprising the corresponding edge.

13. The method of claim 10, wherein
the method further comprises, in each node neuron in the set of node neurons:
responsive to the node neuron corresponding to a candidate end node forming part of the selected path:
updating the indication of the current compute resources available at the corresponding candidate end node by reducing the indication of current compute resources by the requested compute resources, C; and
updating the indication of current memory resources available at the corresponding candidate end node by reducing the indication of the current memory resources by the requested memory resources, M.

14. The method of claim 13, wherein
the method further comprises, in each node neuron in the set of node neurons:
responsive to the node neuron updating the indication of the current compute resources and the indication of the current memory resources available at the corresponding candidate end node, transmitting a spike encoding of the indication of the current compute resources and the indication of the current memory resources to each path neuron corresponding to a candidate path comprising the corresponding candidate end node.

15. The method of claim 8, wherein
the step of the service request neuron selecting a selected path corresponding to a selected path neuron comprises intent based prioritization is used for multiple-end points.

16. (canceled)

17. A network service manager for determining a selected path for delivering a service through a network infrastructure, wherein the network infrastructure comprises a plurality of candidate paths for delivery of the service from a source node to one or more candidate end nodes, the NSM comprising processing circuitry configured to cause the NSM to perform a method comprising:
receiving a service request from a first network node for a service, wherein the service request indicates one or more requested service parameters;
sparse spike sequence encoding the one or more requested service parameters to generate an encoded service level agreement;
obtaining a resource graph representative of the network infrastructure, wherein the resource graph comprises nodes and edges between the nodes; and
utilizing the encoded SLA and the resource graph to select the selected path from the plurality of candidate paths for use in provision of the service, wherein
utilizing the encoded SLA and the resource graph to select the selected path from the plurality of candidate paths for use in provision of the service comprises:
inputting the encoded SLA into a spike neural network derived from the resource graph; and
responsive to a change in the network infrastructure, updating the SNN to incorporate resulting changes to the resource graph.

18. The NSM of claim 17, wherein
the method further comprises outputting an indication of the selected path to the first network node.

19. A non-transitory computer readable storage medium storing a computer program comprising instructions for configuring a network service manager comprising processing operable to execute the instructions to perform the method of claim 1.

20-21. (canceled)
